(19) United States
(12) Patent Application Publication
(10) Pub. No.: US 2021/0385269 A1
(43) Pub. Date: Dec. 9, 2021

(54) TOUCH READING SYSTEM FOR PLAYING CLOUD-BASED AUDIO AND VIDEO CONTENTS THROUGH APPLICATION SOFTWARE

(71) Applicant: CHUN-HUANG LIN, Taipei (TW)

(72) Inventor: CHUN-HUANG LIN, Taipei (TW)

(21) Appl. No.: 16/896,249

(22) Filed: Jun. 9, 2020

(51) Int. Cl. H04L 29/08; G06F 3/14; G06K 7/14

(52) U.S. Cl. CPC H04L 67/10; G06K 2007/10524; G06K 7/1404; G06F 3/14

(57) ABSTRACT

A touch reading system for playing cloud-based audio and video contents through application software (APP) includes a book with an invisible printed code and a touch reading pen with a wireless transmission function. The touch reading pen can obtain a digital number from the book and transmit the digital number to a smart device with APP supported by an arbitrary one of the existing operating systems. The touch reading system allows audio and video contents to be played by devices other than a displaying device, and can connect to a cloud server through the networking function of the smart device so that the desired video contents can be easily downloaded, updated, and managed through the APP to increase the videos available to be played. The touch reading system adopts a cross-platform APP system and supports all the currently mainstream operating systems such as Android, Windows, and iOS.

### BACKGROUND OF THE INVENTION

### 1. Technical Field

The present invention relates to a touch reading system for playing cloud-based audio and video contents. More particularly, the invention relates to a touch reading system for playing cloud-based audio and video contents through application software (APP).

### 2. Description of Related Art

Touch reading pens are a new-generation smart reading and learning tool that incorporates the latest optical image recognition techniques with advanced digital voice technology. These pens embody a perfect match between an electronic product and the education industry and put into practice the notion that technology should be based on human needs. A touch reading pen may have various functions, including for example touch reading, rereading, shadow reading, voice recording, and entertainment.

Currently, a touch reading pen can only play the audio files stored in itself, and a video playing system that entails connecting a touch reading pen to a TV set requires the touch reading pen to work with a video playing machine provided at the same location as the TV set in order for the video playing machine to transmit video signals to the TV set. It follows that the existing touch reading pens and the aforesaid video playing systems are subject to limitations imposed by the environment where they are used. Moreover, as the touch reading pen in a foregoing video playing system must be used in conjunction with a video playing machine and can only be connected to a TV set, a system user cannot freely choose the playing device or connect the touch reading pen to a smart device in place of the TV set. Furthermore, videos available to be played by such a system are limited to those in the local storage of the video playing machine, cannot be updated, and have nothing to do with the resources in a cloud server. Besides, a video playing machine is a closed single-disc system that neither can be expanded in function nor supports any, let alone a plurality, of the currently mainstream operating systems/platforms such as Android, Windows, and iOS.

In addition, the existing touch reading pens require a large-capacity built-in memory for storing audio files or programs. Such memories, however, lead to a high production cost. It is therefore an important issue in the touch reading pen industry to reduce the use of costly memories.

### BRIEF SUMMARY OF THE INVENTION

One objective of the present invention is to solve the foregoing problems of the prior art by providing a touch reading system for playing cloud-based audio and video contents through APP.

To achieve the above objective, the present invention provides the following technical solution:

A touch reading system for playing cloud-based audio and video contents through APP includes a book and a touch reading pen. The book has an invisible printed code, and the touch reading pen has a wireless transmission function. The touch reading pen with the wireless transmission function obtains a digital number from the book with the invisible printed code and transmits the digital number to a smart device with APP, wherein the APP is supported by an arbitrary one of the existing operating systems.

According to a further solution of the present invention, the smart device may be, for example, a TV set, a mobile phone using an Android operating system, a mobile phone using an iOS operating system, a tablet computer, or a laptop computer.

According to a further solution of the present invention, the APP has such functions as managing user information, downloading audio contents, downloading video contents, managing cloud-based books, and playing audio and video contents.

According to a further solution of the present invention, the APP supported by the arbitrary one of the existing operating systems is subjected to cloud-based management and is managed via a cloud server.

According to a further solution of the present invention, the APP supported by the arbitrary one of the existing operating systems includes APP for playing audio and video contents digitally.

According to a further solution of the present invention, the touch reading pen with the wireless transmission function provides Wi-Fi or Bluetooth connectivity.

The present invention overcomes such drawbacks of the prior art as the high production cost resulting from the large-capacity built-in memory required by a conventional touch reading pen to store audio files or programs. The invention is so designed that the touch reading pen with the wireless transmission function can obtain the digital number from the book with the invisible printed code and transmit the digital number to the smart device with the APP supported by the arbitrary one of the existing operating systems, so there is no need to store all the data in the memory in the touch reading pen. The touch reading system of the invention, therefore, has a lower cost than the prior art, which helps encourage extensive use of the system.

According to a further solution of the present invention, the smart device provides Wi-Fi or Bluetooth connectivity.

The present invention has the following advantageous effects over the prior art:

1. As the system of the present invention supports and can work with TV sets, set-top boxes, tablet computers, mobile phones, laptop computers, desktop computers, and other mainstream smart devices, one who uses the system can play audio and video contents via devices other than a displaying device.

2. Video contents available to be played by the system of the present invention can be updated and increased. The system of the invention can connect to a cloud server through the networking function of the smart device so that a user can easily download, update, and manage the desired video contents through the APP in the smart device.

3. The system of the present invention adopts a cross-platform APP system so that by developing the required APP for each of the currently mainstream operating systems (e.g., Android, Windows, and iOS), the system of the invention can be made compatible with all such operating systems.

### DETAILED DESCRIPTION OF THE INVENTION

The present invention provides a touch reading system for playing cloud-based audio and video contents through APP. The touch reading system includes a book with an invisible printed code and a touch reading pen with a wireless transmission function. The touch reading pen with the wireless transmission function provides Wi-Fi or Bluetooth connectivity and is configured to obtain a digital number from the book with the invisible printed code and transmit the digital number to a smart device, wherein the smart device has APP supported by an arbitrary one of the existing operating systems and provides Wi-Fi or Bluetooth connectivity. The functions of the APP include managing user information, downloading audio contents, downloading video contents, managing cloud-based books, and playing audio and video contents. The APP supported by the arbitrary one of the existing operating systems is subjected to cloud-based management and is managed via a cloud server. The APP supported by the arbitrary one of the existing operating systems includes APP for playing audio and video contents digitally. The smart device may be a TV set, a mobile phone using an Android operating system, a mobile phone using an iOS operating system, a tablet computer, a laptop computer, or the like.

One who uses the system of the present invention can play audio and video contents via devices other than a displaying device because the system supports and can work with TV sets, set-top boxes, tablet computers, mobile phones, laptop computers, desktop computers, and other mainstream smart devices. In addition, video contents available to be played by the system of the invention can be updated and increased. More specifically, the system of the invention can connect to a cloud server through the networking function of the smart device so that a user can easily download, update, and manage the desired video contents through the APP in the smart device. Furthermore, the system of the invention adopts a cross-platform APP system and hence can be made compatible with all the currently mainstream operating systems (e.g., Android, Windows, and iOS) by developing the required APP for each operating system.

The present invention overcomes such drawbacks of the prior art as the high production cost resulting from the large-capacity built-in memory required by a conventional touch reading pen to store audio files or programs. The invention is so designed that the touch reading pen with the wireless transmission function can obtain the digital number from the book with the invisible printed code and transmit the digital number to the smart device with APP supported by the arbitrary one of the existing operating systems; consequently, there is no need to store all the data in the memory in the touch reading pen. The system of the invention, therefore, has a lower cost than the prior art, which helps encourage extensive use of the system.

What is claimed is:

1. A touch reading system for playing cloud-based audio and video contents through application software (APP), comprising a book with an invisible printed code and a touch reading pen with a wireless transmission function, characterized in that the touch reading pen with the wireless transmission function is configured to obtain a digital number from the book with the invisible printed code and transmit the digital number to a smart device with APP supported by an arbitrary one of existing operating systems.

2. The touch reading system for playing cloud-based audio and video contents through APP as claimed in claim 1, wherein the smart device is one selected from the group consisting of a TV set, a mobile phone using an Android operating system, a mobile phone using an iOS operating system, a tablet computer, and a laptop computer.

3. The touch reading system for playing cloud-based audio and video contents through APP as claimed in claim 1, wherein the APP serves to manage user information, download audio contents, download video contents, manage cloud-based books, and play audio and video contents.

4. The touch reading system for playing cloud-based audio and video contents through APP as claimed in claim 1, wherein the APP supported by the arbitrary one of the existing operating systems is subjected to cloud-based management and is managed via a cloud server.

5. The touch reading system for playing cloud-based audio and video contents through APP as claimed in claim 1, wherein the APP supported by the arbitrary one of the existing operating systems includes APP for playing audio and video contents digitally.

6. The touch reading system for playing cloud-based audio and video contents through APP as claimed in claim 1, wherein the touch reading pen with the wireless transmission function provides connectivity through a wireless transmission means selected from the group consisting of Wi-Fi and Bluetooth.

7. The touch reading system for playing cloud-based audio and video contents through APP as claimed in claim 1, wherein the smart device provides connectivity through Wi-Fi or Bluetooth.

8. The touch reading system for playing cloud-based audio and video contents through APP as claimed in claim 1, wherein the touch reading pen with the wireless transmission function has a memory loaded only with fundamental operating software but not with voice data.
